(19) United States
(12) Patent Application Publication
(10) Pub. No.: US 2004/0100146 A1
(43) Pub. Date: May 27, 2004

(54) Method for operating an electronically adjustable brake actuation system

(76) Inventors: Bernhard Giers, Frankfurt (DE); Robert Schmidt, Rennerod (DE); Andreas Klein, Bad Homburg (DE); Stefan Stolzl, Weinheim (DE); Ralf Junge, Steinbach (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/432,342

(22) PCT Filed: Oct. 26, 2001
(86) PCT No.: PCT/EP01/12383

(30) Foreign Application Priority Data
Nov. 21, 2000 (DE) 10057815.2

(51) Int. Cl. B60T 8/88

(52) U.S. Cl. 303/122

(57) ABSTRACT

In a method for operating an electronically adjustable brake actuation system for motor vehicles comprising a de-pressurized hydraulic fluid reservoir (4), a pressure source (20) that can be controlled by means of an electronic control unit (31) and whose pressure is adapted to be applied to wheel brakes (6, 7; 13, 14) of the vehicle, a device (2, 32, S₁) for identifying the deceleration requested by the driver, as well as valve devices (8, 10, 11, 16, 17, 18, 19, 26, 27) connected upstream of the wheel brakes (6, 7; 13, 14), the wheel brakes (6, 7; 13, 14) are connectable alternatively to the pressure source (20) or to the pressure fluid reservoir (4).

To simplify the operation of the brake actuation system after fault detection, the invention discloses a first fixed predetermined fallback mode with a linked actuation of pairs of wheel brakes (6, 13; 7, 14 or 6, 14; 7, 13) on different axles.

The present invention relates to a method for operating an electronically adjustable brake actuation system for motor vehicles comprising a depressurized hydraulic fluid reservoir, at least one pressure source that can be controlled by means of an electronic control unit and whose pressure is adapted to be applied to wheel brakes of the vehicle, a device for identifying the deceleration requested by the driver and with means for detecting a fail condition, as well as valve devices connected upstream of the wheel brakes and connecting the wheel brakes alternatively to the pressure source or to the pressure fluid reservoir, wherein an electrohydraulic normal actuating mode and a hydraulic fallback mode for a fail condition is arranged for.

An electronically adjustable brake actuation system is e.g. known from the article ‘Electrohydraulic Brake System—The First Approach to Brake-By-Wire Technology’, SAE Paper 960991. Because a vehicle operator is uncoupled from the generation of brake forces in electrohydraulic brake actuation systems (EHB) and the execution of the braking request occurs so-to-speak ‘by wire’, a set-point generator with simulator is employed that reproduces the pedal feeling achieved on account of actuation in a way comparable to the reaction of a conventional brake system. Further, the set-point generator comprises a master cylinder permitting a hydraulic emergency braking mode in the event of malfunction of the electronics by means of a direct actuation of the wheel brakes (so-called hydraulic fallback mode). As soon as a request for actuation is detected in the by-wire mode because e.g. actuation of a brake pedal is sensed, separating valves are being closed in order to shut off a direct hydraulic through grip of the master cylinder in the direction of the wheel brakes. While brake pressure build-up is initiated in an electrohydraulic fashion, the vehicle operator experiences a reaction force due to displacement of volume into the simulator that corresponds to the actuating movement.

To avoid unnecessary disconnections of the system due to failure detection, the above-mentioned publication discloses a failure diagnosis with individually graded fallback modes. The individual error causes are isolated for this purpose. When a defined fail condition is detected and localized, which prevents the electrohydraulic actuation of only one certain wheel brake, a direct hydraulic through grip of the brake from the master cylinder to the wheel brake concerned is activated, and the remaining wheel brakes continue to be actuated in an electrohydraulically boosted fashion (so-called three-wheel EHB). Only when critical faults occur, such as current failure, will a complete deactivation of the EHB function be considered. A hybrid system with hydraulic and electrohydraulic actuation components is out of the question for various reasons.

German patent application DE 198 07 366 A1 discloses a method for adjusting an electrohydraulic brake system with different, individually adapted emergency brake operating states. After detecting and localizing defined errors, a partial system deactivation will be brought about which is in each case adapted individually to the fail condition detected. When the EHB function of a defined wheel is disturbed, a three-wheel EHB operation will be executed, with exclusively the failing vehicle wheel being braked hydraulically by manual operation.

An additional yaw torque limitation is proposed for counteracting a skidding tendency of a vehicle braked that way. Depending on the type of malfunction and condition of the system, the brake actuation system will be transferred to different fallback modes and effect a successive adaptation of the system functionalities.

Fault detection and fault localization as well as an individual adaptation of the fallback mode to the respective case of malfunction are sophisticated. As there is the need to execute the calculations for fault localization quasi in real time that means very quickly and in parallel to control processes being carried out—the methods known in the art necessitate a considerable calculation capacity along with corresponding costly hardware.

An object of the present invention is to provide a method for operating an electronically adjustable brake actuation system, which method is simple and quicker to implement and can be realized with reasonable expenditure in hardware.

This object is achieved by the present invention in that, upon detection of a driver's request for deceleration and upon detection of a fail condition, a first fixed predetermined fallback mode with a linked actuation of pairs of wheel brakes on different axles is provided. The invention offers the advantage of reducing the hardware needed for data processing because there is provision of a fixed predetermined fallback mode. Error localization or an individually adapted fallback mode is not effected. The volume of data to be processed per time unit is reduced.

A favorable aspect of the idea of the present invention arranges for a first pair of wheel brakes to be operated electrohydraulically, and a second pair of wheel brakes to be operated exclusively hydraulically because there is a direct connection between a master cylinder and the wheel brakes in the first fallback mode, and because there is a hydraulic isolation of the wheel brakes of an axle. This hybrid actuation systematics permits an improved deceleration performance of the vehicle compared to a complete system deactivation (hydraulic fallback mode on all four wheels). This is because the electrohydraulic actuation mode—apart from a servo effect allows e.g. a better compensation of infiltrated gas elements. Because at least two wheel brakes are isolated from the purely hydraulic actuation, the pressure fluid volume prevailing in the master cylinder will be available in a case of malfunction entirely for the pressure increase in the other two, purely hydraulically actuated wheel brakes and may be used to produce brake forces at an accordingly increased rate. As the pedal behavior will change due to the hydraulic actuation of two wheel brakes in the sense of increased actuating forces, the vehicle operator experiences a motivation to repair the brake system which is not provided in a three-wheel EHB.

Provision can be made that the wheel brakes of a linked pair of brakes are arranged diagonally opposite each other with respect to the vehicle's driving direction. This arranges for a compensation of torques about the vertical axis of the vehicle automatically, i.e., without the necessity of yaw torque control, and counteracts a tendency to skid.

In a favorable embodiment of the invention, a right wheel brake on a front axle linked to a left wheel brake on a rear axle is operated electrohydraulically, and a left wheel brake on a front axle is hydraulically operable linked to a right wheel brake on a rear axle. Reverse allocation is also feasible.

It is favorable when a second fallback mode with exclusively hydraulic actuation of all wheel brakes is provided, wherein the wheel brakes are linked per axles for the hydraulic actuation, and a direction connection is established between the master cylinder and the wheel brakes, there being a hydraulic pressure compensation between the wheel brakes of an axle. The second fallback mode will always commence when the first fallback mode is not sufficient, for example, in the event of total breakdown of the electrical supply system.

A simple construction and a simple actuation is achieved when a pressure compensation valve is provided for the pressure compensation between the wheel brakes of an axle, said valve being controlled to adopt a de-energized open position in the second fallback mode. In the event of breakdown of the electrical supply system, the pressure compensation valve will consequently drop quasi automatically into the condition of the second fallback mode.

This invention will be explained in detail by way of the following description of an embodiment by making reference to the accompanying schematic drawings.

In the drawings,

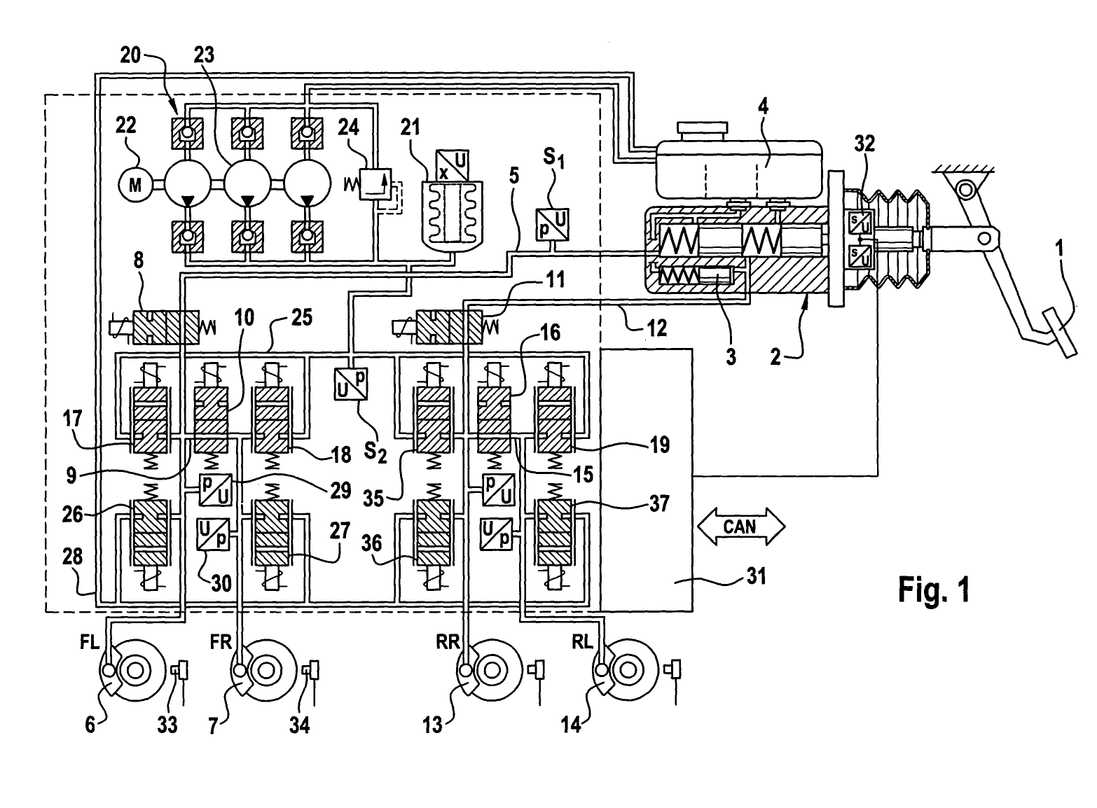

FIG. 1 is a view of a brake actuating system in the second fallback level (currentless switch positions of all valve assemblies).

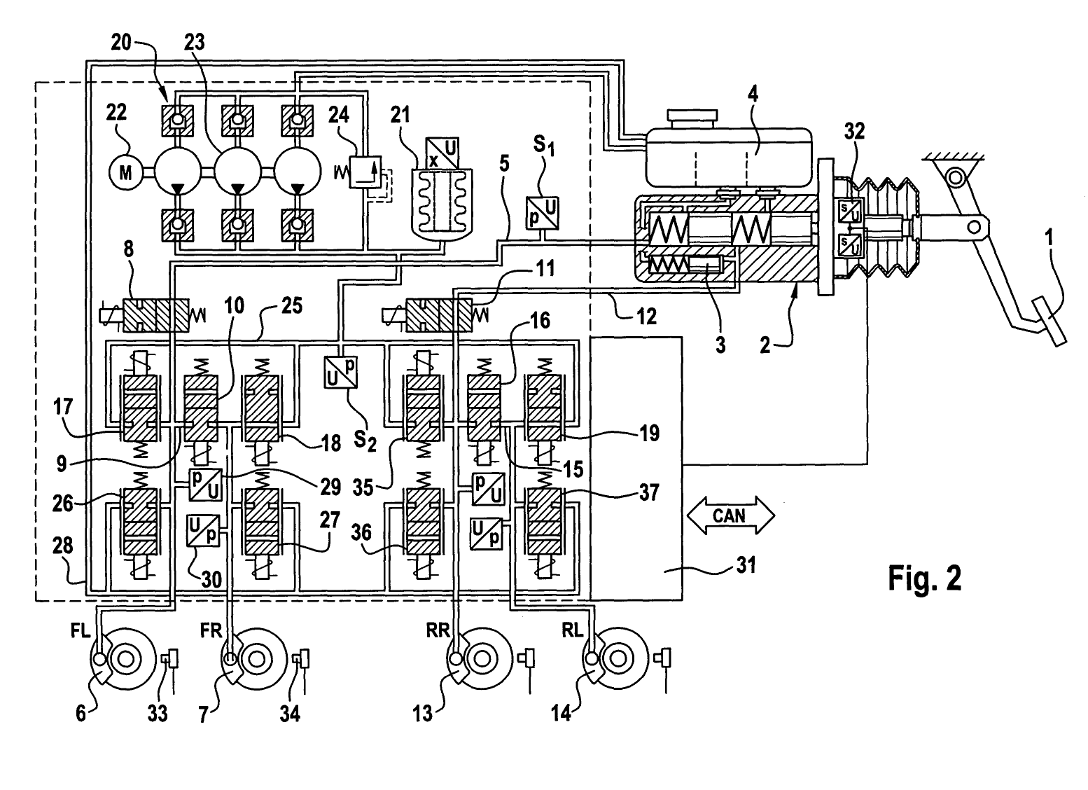

FIG. 2 is a view of a brake actuating system like in FIG. 1, however, in the first fallback mode.

An electronically controllable brake actuation system comprises a dual-circuit master cylinder or tandem master cylinder 2 that is operable by means of an actuating pedal 1, cooperates with a simulator 3 and includes two pressure chambers isolated from one another and being in communication with a non-pressurized pressure fluid reservoir 4. Wheel brakes 6, 7 e.g. associated with the front axle are connected to a first pressure chamber by means of a closable first hydraulic line 5 wherein a pressure sensor S₁ is incorporated. As can be seen, the wheel brakes of the front axle and the wheel brakes of the rear axle are operable in a linked manner in respectively one separate brake circuit in the second fallback mode shown. Line 5 is closed by means of a first separating valve 8 for an electrohydraulic normal braking operation, while in a line portion 9 between the wheel brakes 6, 7 an electromagnetically operable, preferably normally open (NO) pressure compensating valve 10 is inserted which, when in its closed condition, enables brake pressure control on each individual wheel.

The second pressure chamber of the master brake cylinder 2 is connectable to a pair of wheel brakes 13, 14 associated with the rear axle by way of a second hydraulic line 12 closable by means of a second separating valve 11. An electromagnetically operable, preferably normally open (NO) pressure compensating valve 16 is inserted into a line portion 15 disposed between the wheel brakes 13, 14. The design of the circuit and the function of the rear-axle brake circuit are identical to the front-axle circuit explained in the preceding description.

As can be taken from FIG. 1, a motor-and-pump assembly with a high-pressure accumulator 21 is used as a pressure source 20, said assembly comprising a pump 23 driven by means of an electric motor 22 and having preferably a plurality of parallel connected supply devices as well as a pressure limiting valve 24 connected in parallel to said pump 23. The suction side of the pump 23 is connected to the above-mentioned pressure fluid reservoir 4 by way of a non-return valve. A pressure sensor S₂ monitors the hydraulic pressure generated by the pump 23.

A third hydraulic line 25 connects the high-pressure accumulator 21 to inlet ports of two electromagnetic, normally closed two-way/two-position directional control valves 17, 18 of analog operation which are connected upstream of the wheel brakes 6 and 7 in the capacity of inlet valves. Further, the wheel brakes 6, 7 are connected to a fourth hydraulic line 28 by way of each one electromagnetic, normally closed two-way/two-position directional control valve or outlet valve 26, 27 of analog operation, said line 28 being in communication with the non-pressurized pressure fluid reservoir 4, on the other hand. The hydraulic pressure prevailing in the wheel brakes 6, 7 is determined by means of each one pressure sensor 29, 30. There is provision of four two-way/two-condition directional control valves 19, 35; 36, 37 as inlet or outlet valves in a corresponding fashion for the wheel brakes 13, 14 of the rear axle, what need not be explained in detail.

An electronic control unit 31 (ECU) is used for the joint actuation of the motor-and-pump assembly 20 as well as the electromagnetic valves 8, 10, 11, 16, 17, 18, 19, 26, 27, 35, 36, 37. The output signals of an actuating travel sensor 32 cooperating with the actuating pedal 1 and of the above-mentioned pressure sensor S₁ are sent as input signals to said control unit 31, thereby permitting detection of the driver's deceleration demand. However, other means such as a force sensor sensing the actuating force at the actuating pedal 1 may also be used for the detection of the driver's deceleration demand. As further input quantities, the output signals of the pressure sensors 29, 30 as well as the output signals of wheel sensors 33, 34 (only represented) are sent to the electronic control unit 31. A fail condition of the brake actuation system may be detected in the ECU on the basis of this information. The fail conditions and the methods for detection thereof may be manifold. The disclosure of German patent application DE 100 60 225 A1 shall be referred to as an example herein.

According to FIG. 1, all electromagnetically operated valves adopt the de-energized state of the second fallback mode. With the separating valves 8, 11 being open in their de-energized condition, the master cylinder is hydraulically connected to the wheel brakes 6, 7, 13, 14 by way of lines 5, 12, and the wheel brakes of one axle are hydraulically bypassed in pairs with pressure compensating valves 10, 16 open in their de-energized condition. All other valves 17, 18, 19, 26, 27, 35, 36, 37 are shown in their de-energized closed condition. The circuit allocation with wheel brakes linked axle-wise in each case is principally referred to as black and white split-up. This mode is adopted if a critical fault disables the entire EHB operation.

According to FIG. 2, there is provided a fixed predetermined first fallback mode that is logically arranged before the second fallback mode when a driver's deceleration demand is identified and a less critical fault is detected. The first fallback mode permits an actuation of wheel brakes 6, 7, 13, 14 of different axles linked in pairs without necessitating precise fault localization. The actuation of the wheel brakes 6, 7, 13, 14 in each case is carried out in pairs and, namely, in a different fashion because one wheel brake pair 7, 14 is now as before actuated electrohydraulically, and the other wheel brake pair 6, 13 is actuated in a hydraulically direct way. This is done by control of the separating valves 8, 11 to assume their open condition and the pressure compensating valves 10, 16 to assume the closed condition. In other words, the wheel brakes 6, 7; 13, 14 of one axle are isolated hydraulically from each other. The result is that the wheel brakes (6, 13) left front with right rear wheel brake) that are arranged diagonally to each other when viewed in the driving direction, are operable directly hydraulically. A controlled actuation of the other wheel brake pair 7, 14 (right front wheel brake with left rear wheel brake) is effected electrohydraulically by a controlled opening and closing of two-way/two-position directional control valves 18, 19, 27, 37 and pressurization by way of high-pressure accumulator 21 or pump 23.

In the first fallback mode there is a hybrid brake actuation by applying purely hydraulic means and by simultaneously applying electrohydraulic means, the said means being evenly distributed over the number of wheel brakes, thereby reducing the expenditure for the operation of the brake actuation system.

| | |
|---|---|
| 1 | actuating pedal |
| 2 | tandem master cylinder |
| 3 | simulator |
| 4 | pressure fluid reservoir |
| 5 | line |
| 6 | wheel brake |
| 7 | wheel brake |
| 8 | separating valve |
| 9 | line portion |
| 10 | pressure compensating valve |
| 11 | separating valve |
| 12 | line |
| 13 | wheel brake |
| 14 | wheel brake |
| 15 | line portion |
| 16 | pressure compensating valve |
| 17 | 2/2 control valve |
| 18 | 2/2 control valve |
| 19 | 2/2 control valve |
| 20 | pressure source |
| 21 | high-pressure accumulator |
| 22 | electric motor |
| 23 | pump |
| 24 | pressure-limiting valve |
| 25 | line |
| 26 | outlet valve |
| 27 | outlet valve |
| 28 | line |
| 29 | pressure sensor |
| 30 | pressure sensor |
| 31 | control unit |
| 32 | actuating travel sensor |
| 33 | wheel sensor |
| 34 | wheel sensor |
| 35 | 2/2 control valve |
| 36 | 2/2 control valve |
| 37 | 2/2 control valve |
| S₁ | pressure sensor |
| S₂ | pressure sensor |

1. Method for operating an electronically adjustable brake actuation system for motor vehicles comprising a de-pressurized hydraulic fluid reservoir (4), at least one pressure source (20) that can be controlled by means of an electronic control unit (31) and whose pressure is adapted to be applied to wheel brakes (6, 7; 13, 14) of the vehicle, a device (2, 32, S₁) for identifying the deceleration requested by the driver and with means for detecting a fail condition, as well as valve devices (8, 10, 11, 16, 17, 18, 19, 26, 27, 35, 36, 37) connected upstream of the wheel brakes (6, 7; 13, 14) and connecting the wheel brakes (6, 7; 13, 14) alternatively to the pressure source (20) or to the pressure fluid reservoir (4), wherein an electrohydraulic normal actuating mode and a hydraulic fallback mode for a fail condition is arranged for, characterized in that upon detection of a driver's request for deceleration and upon detection of a fail condition, there is provision of a first fixed predetermined fallback mode with a linked actuation of pairs of wheel brakes (6, 13; 7, 14 or 6, 14; 7, 13) on different axles.

2. Method as claimed in claim 1, characterized in that a first pair of wheel brakes (7, 14 or 7, 13) is operated electrohydraulically, and in that a second pair of wheel brakes (6, 13 or 6, 14) is operated exclusively hydraulically because there is a direct connection between a master cylinder (2) and the wheel brakes (7, 14 or 7, 13) in the first fallback mode, and because there is a hydraulic isolation of the wheel brakes (6, 7; 13, 14) of one axle.

3. Method as claimed in claim 1 or 2, characterized in that the wheel brakes (6, 13; 7, 14 or 6, 14; 7, 13) of a pair are arranged diagonally opposite to each other, with respect to the vehicle's driving direction.

4. Method as claimed in claim 3, characterized in that a right wheel brake (7) on a front axle linked to a left wheel brake (14) on a rear axle is operated electrohydraulically, and in that a left wheel brake (6) on a front axle is hydraulically operated by being linked to a right wheel brake (13) on a rear axle, or vice versa.

5. Method as claimed in any one or more of the preceding claims, characterized in that a second fallback mode with exclusively hydraulic actuation of all wheel brakes (6, 7; 13, 14) is provided, wherein the wheel brakes (6, 7; 13, 14) are linked per axles for the hydraulic actuation, and a direct connection is established between the master cylinder (2) and the wheel brakes (6, 7; 13, 14), there being a hydraulic pressure compensation between the wheel brakes (6, 7; 13, 14) of an axle.

6. Method as claimed in claim 5, characterized in that a pressure compensation valve (10, 16) is provided for the pressure compensation between the wheel brakes (6, 7; 13, 14) of an axle, said valve being controlled to adopt a de-energized open position in the second fallback mode.
